(19) United States
(12) Patent Application Publication
(10) Pub. No.: US 2002/0073423 A1
(43) Pub. Date: Jun. 13, 2002

(54) System, method and program product for displaying simultaneously video content and supplemental information without obstructing video content

(76) Inventor: Haig Krakirian, Burbank, CA (US)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/734,688

(22) Filed: Dec. 13, 2000

Related U.S. Application Data
(60) Provisional application No. 60/170,543, filed on Dec. 14, 1999.

(51) Int. Cl. G06F 3/00; H04N 5/445; G06F 13/00; H04N 7/173

(52) U.S. Cl. 725/40; 725/42; 348/563; 725/112

(57) ABSTRACT

A method, computer system and computer program product which enables a user to simultaneously view video content and supplemental information. A first video content is converted to a format wherein the first video content is reduced in size and displayed on a first portion of a display; and data associated with the supplemental information is converted to a format for display on a second portion of the display at the same time as the video content is displayed on the first portion of the display. In one aspect of the invention, a television viewer is able to watch a broadcast television program and simultaneously view information about the show being watched without obstructing any of the broadcast content. In another aspect, a television viewer is able to retrieve information about other shows, while staying tuned to a single broadcast channel and without obstructing that channel's broadcast content. In yet another aspect, a broadcast message is displayed without obstructing the current broadcast content on the television screen. Other aspects of the invention relate to video content received from sources such as the internet.

This application is filed under 35 U.S.C. 111(a) claiming pursuant to 35 U.S.C. 119(e)(1) benefit of the filing date of provisional application Ser. No. 60/170,543 filed Dec. 14, 1999, pursuant to 35 U.S.C. 111(b).

### BACKGROUND OF THE INVENTION

1. Field of the Invention

The invention is embodied in a system, a method, and a program product for displaying information on a display, and more particularly to a method for displaying simultaneously on a display video content and supplemental information without obstructing the video content.

2. Description of Related Art

Currently, in most advanced television viewing devices, viewers are able to view broadcast video signals and simultaneously get program information about the shows they are watching. One problem with existing devices is that the program information obstructs the video broadcast content by overlaying the information on top of the video. This presents a problem with viewers and content programmers where the overlaid information potentially obscures important information which is being broadcast or prevents viewing content that was purposely created to be shown as a whole.

There are some existing devices that attempt to remedy this problem by providing translucent overlays. Though this approach does address the problem of not completely obscuring the underlying information, the result is not entirely satisfactory, since neither the overlay nor the background video is clear to the viewer. The overlaid text is hard to read, and the background video remains difficult to see.

Another feature currently available in some devices is the ability to display one broadcast video program while simultaneously displaying textual information about other shows and programs broadcast on other channels and/or at other times. This feature allows one viewer in a household to continue watching a television show, while another viewer is ‘scanning’ program information looking for other programming. Again, existing devices have provided this functionality of displaying event information at the expense of obstructing the video content. The devices overlay the ‘scanned’ information on top of the video content, thus obstructing a good portion of the broadcast video program.

Still another feature currently available in some devices is the ability to display one broadcast video program while simultaneously displaying textual information about other shows and programs broadcast on other channels and/or at other times, with the broadcast video program being displayed on only a small portion of the screen. However, because the broadcast video program is displayed on only a small portion of the screen, it is difficult to view the broadcast video program.

### SUMMARY OF THE INVENTION

It is therefore an object of the invention to provide a method which enables a user to simultaneously view video content and supplemental information.

It is another object of the invention to provide a computer system which enables a user to simultaneously view video content and supplemental information.

It is still another object of the invention to provide a computer program product which enables a user to simultaneously view video content and supplemental information.

In order to achieve the first object of the invention, a method is is provided so that a video content is converted to a format wherein the video content is displayed on a first portion of a display in reduced size; and data associated with the supplemental information is converted to a format for display on a second portion of the display at the same time as the video content is displayed on the first portion of the display.

In order to achieve the second object of the invention, a computer system is provided which is adapted to simultaneously display a video program and supplemental information. The computer system includes a processor, and a memory including software instructions adapted to enable the computer system to perform the steps of: converting a video content to a format wherein the video content is reduced in size and displayed on a first portion of a display; and converting data associated with the supplemental information to a format wherein textual and/or graphic content representing at least a portion of the supplemental information is displayed on a second portion of the display at the same time as the video content is displayed on the first portion of the display.

In order to achieve the third object of the invention, a computer program product is provided which enables a computer to simultaneously display a video program and supplemental information. The computer program product includes software instructions which enable the computer to perform predetermined operations, and a computer readable medium bearing the software instructions. The predetermined operations include the steps of: converting a video content to a format wherein the video content is reduced in size and displayed on a first portion of a display; and converting data associated with the supplemental information to a format wherein textual and/or graphic content representing the supplemental information is displayed on a second portion of the display different from the first portion of the display at the same time as the video content is displayed on the first portion of the display.

In one exemplary application of the invention, a television viewer is able to watch a broadcast television program and simultaneously view information about the show being watched without obstructing any of the broadcast content. In another exemplary aspect of the invention, a television viewer is able to retrieve information about other shows, while staying tuned to a single broadcast channel and without obstructing that channel's broadcast content. In yet another exemplary application of the invention, a broadcast message is displayed without obstructing the current broadcast content on the television screen.

### BRIEF DESCRIPTION OF THE DRAWINGS

The above objectives and advantages of the present invention will become more apparent by describing in detail a preferred embodiment thereof with reference to the attached drawings in which:

FIG. 1 is a block diagram of a system for implementing an embodiment of the invention.

FIG. 2 is an example of how an embodiment of the invention displays video material.

### DESCRIPTION OF THE PREFERRED EMBODIMENT

Definitions

### Computer Systems

One embodiment of this invention resides in a computer system. Here, the term “computer system” is to be understood to include at least a memory and a processor. It is also to be understood that the term “computer system” is to be interpreted broadly enough to include devices, such as, but not limited to, a television receiver, which include a memory and a processor, but which are not normally referred to as computers or computer systems. In general, the memory will store, at one time or another, at least portions of an executable program code, and the processor will execute one or more of the instructions included in that executable program code. It will be appreciated that the term “executable program code” and the term “software” mean substantially the same thing for the purposes of this description. It is not necessary to the practice of this invention that the memory and the processor be physically located in the same place. That is to say, it is foreseen that the processor and the memory might be in different physical pieces of equipment or even in geographically distinct locations.

### Computer Program Products

The above-identified invention may be embodied in a computer program product, as will now be explained.

On a practical level, the software that enables the computer system to perform the operations described further below in detail, may be supplied on any one of a variety of media. Furthermore, the actual implementation of the approach and operations of the invention are actually statements written in a programming language. Such programming language statements, when executed by a computer, cause the computer to act in accordance with the particular content of the statements. Furthermore, the software that enables a computer system to act in accordance with the invention may be provided in any number of forms including, but not limited to, original source code, assembly code, object code, machine language, compressed or encrypted versions of the foregoing, and any and all equivalents.

One of skill in the art will appreciate that “media”, or “computer-readable media”, as used here, may include an integrated circuit, a ROM, a diskette, a tape, a compact disc, a cartridge, a remote transmission via a communications circuit, or any other similar medium useable by computers. For example, to supply software for enabling a computer system to operate in accordance with the invention, the supplier might provide an integrated circuit or might transmit the software in some form via satellite transmission, via a direct telephone link, or via the Internet. Thus, the term, “computer readable medium” is intended to include all of the foregoing and any other medium by which software may be provided to a computer.

Although the enabling software might be “written on” a diskette, “stored in” an integrated circuit, or “carried over” a communications circuit, it will be appreciated that, for the purposes of this application, the computer usable medium will be referred to as “bearing” the software. Thus, the term “bearing” is intended to encompass the above and all equivalent ways in which software is associated with a computer usable medium.

For the sake of simplicity, therefore, the term “program product” is thus used to refer to a computer useable medium, as defined above, which bears in any form of software to enable a computer system to operate according to the above-identified invention.

Thus, the invention is also embodied in a program product bearing software which enables a computer to simultaneously display a video program and supplemental information according to the invention.

Description

Hereinafter, a preferred embodiment of the present invention will be described in detail with reference to the attached drawings. Various specific details are shown in the following description and the attached drawings to provide a more general understanding of the present invention. It will be apparent to those skilled in the art that the present invention can be performed without these specific details. Commonly-known functions and configurations, that may make the subject matter of the present invention vague, will not be described.

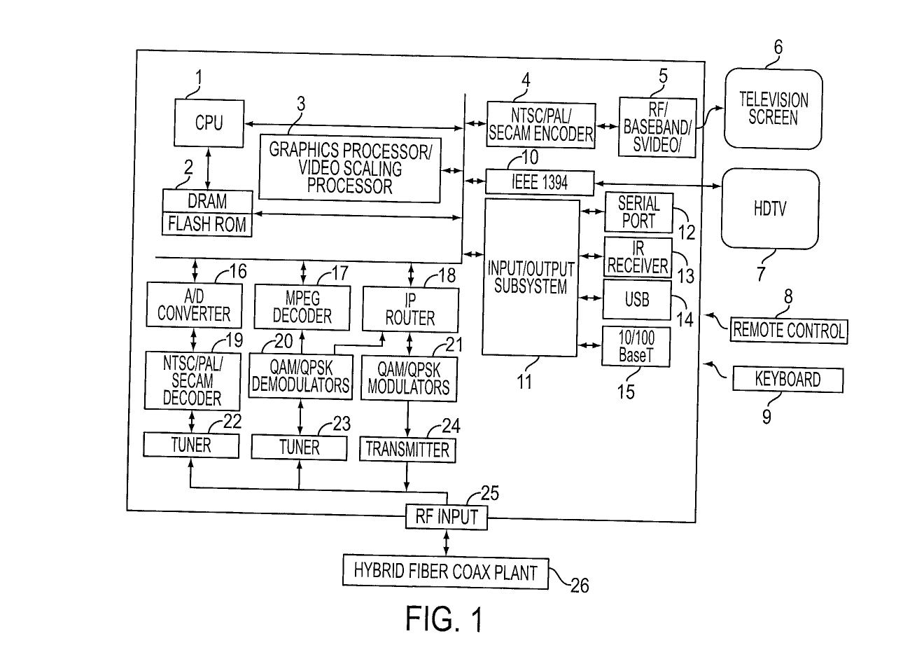

Referring to FIG. 1, one embodiment of the invention uses a CPU 1, a memory 2, a graphics and video scaling processor 3, a video decoder 17 or analog video digitizer 16, a tuner 22 or 23, and a display device 6 or 7 to display data content and video content simultaneously.

A controlling piece of software stored in memory 2 and running on the CPU 1 renders textual and graphical content that is broadcast on a network 26, and instructs the graphics processor 3 to display the rendered information on the screen 6 or 7. The controlling software also instructs the video decoder 17 or video digitizer 16 to digitize a broadcast video source and instructs the video scaling processor 3 to scale the digitized video to a predefined size and location on the screen where it does not overlap with the textual and graphic content which is displayed on the screen. Preferably, the aspect ratio of the original video source is kept intact.

FIG. 1 depicts a system which can receive and display either a digital video signal or an analog video signal. In the case of a digital video signal, tuner 23 selects a signal which is demodulated by QAM/QPSK demodulators 20. If the demodulated signal is MPEG encoded, MPEG decoder 17 decodes the signal and outputs the decoded signal. In the case of an analog video signal, tuner 22 selects a signal which is decoded by NTSC/PAL/SECAM decoder 19 and digitized by A/D converter 16.

If the video signal is a high definition signal, IEEE 1394 (element 10) applies the decoded signal to HDTV screen 7. If the video signal is not a high definition signal, NTSC/PAL/SECAM encoder 14 applies the signal to television screen 6 via RF/BaseBand/SVIDEO element 5.

Additionally, supplemental information is received from the hybrid fiber coax plant 26. The supplemental information may be embedded in the video signal. For example, the supplemental information may be contained in the blanking period of the video signal. Additionally and/or alternatively, the supplemental information may be received from the hybrid fiber coax plant 26 separately from the video signal. The supplemental information may also be received separately from the hybrid fiber coax plant 26. For example, the supplemental information may be received from an over-the-air broadcast such as a satellite or terrestrial broadcast, or it may be received over a telephone line or an internet connection.

It will be understood by one of skill in the art that the system depicted in FIG. 1 is an exemplary system for practicing the present invention, but many other systems are possible. For example, it is not necessary that the system have the capability of handling digital video signals and analog video signals. It is important only that the system be able to handle either analog or digital video signals. Additionally, according to the system depicted in FIG. 1, one or more video programs are broadcast over a hybrid fiber coax plant 26. However, the invention is not limited to this arrangement. For example, video programs may be transmitted over the air, or may be retrieved from a storage medium such as a tape, a video disc or an integrated circuit. Additionally, the video signal is not required to be a video program, but may be a video signal output by a video game, or video content received via the internet, for example.

The system accepts user input through a remote control 8 via IR receiver 13 or through keyboard 9 via serial port 12, and both the IR receiver 13 and the serial port 12 communicate with the CPU via the input/output subsystem 11. The viewer may input a command for paging up and down in the program description area to allow the viewer to see endless textual and graphic information without compromising the screen layout, especially the video display.

Preferably, the viewer may also input a command to scan other programs broadcast on other channels and/or at other times without compromising the screen layout, especially the video display, by simply reusing the text/graphic area to display the newly requested program information. Using directional keys on an input device, the software can be instructed to scan up and down the television channel space to scan information on different events playing on other channels. Also, the software can be instructed to scan left and right in time space to scan information on different events broadcast at other times in the future and the past.

Preferably, the viewer may also input a command to retrieve more information about a displayed message, such as an advertising message, without compromising the screen layout, especially the video display, by simply reusing the text/graphic area for the newly requested information.

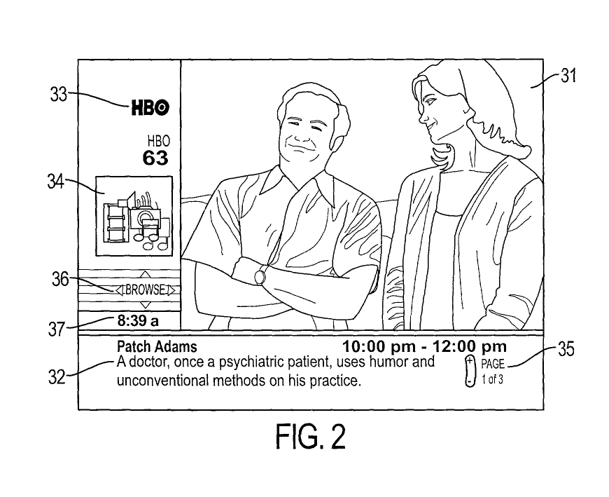

An example of how the invention displays a video signal such as a television program, and supplemental information, such as information relating to the television program, is shown in FIG. 2.

As explained above, tuner 22 or tuner 23 extracts the video signal of a desired channel from the hybrid fiber coax plant 26, and the extracted signal is appropriately decoded. If supplemental information is desired, the viewer enters a command via one of input devices 8 and 9. In response, the CPU 1 instructs the graphics processor/video scaling processor 5 to scale down the size of the video program and to display the scaled down video program on the portion of the display designated by the number 31. Preferably, the aspect ratio of the scaled-down video program displayed in portion 31 is the same as the aspect ratio of the video program before it is scaled down. However, the invention is not limited to the case where the aspect ratio is maintained. Preferably, the display of the currently tuned program occupies a major portion of the screen. In the example of FIG. 2, the display of the currently tuned program is scaled down to about 80% of the screen size.

Supplemental information corresponding to the input command is then displayed on the screen in an area not occupied by region 31. FIG. 2 shows the case where a description 32 of the currently tuned program is displayed. However, a description of a program other than the currently tuned program could be displayed. Number 33 indicates an area of the screen where information with respect to the currently tuned channel is displayed. Number 34 indicates an area of the screen where a message intended for the user is displayed. An example of such a message is an advertising message. Number 35 designates an area of the screen where an indication of the page number of the description of the currently tuned program is displayed. Number 36 indicates an area of the screen where a browse indicator is displayed.

A viewer may enter a command to display information relating to programs other than the currently tuned program. In that event, the information relating to the selected program is displayed in the areas where similar information of the currently tuned channel is displayed. Of course, it is not necessary to stop the display of all of the information of the currently tuned channel. For example, the system may be programmed to display, in region 33, both the channel number of the currently tuned channel and the channel number of the selected program.

A viewer may also enter a command to display message information. For example, the viewer may enter a command to retrieve more information about an advertising message displayed in region 34.

As was explained above, the invention may be embodied in a computer program product.

While this invention has been particularly shown and described with reference to an example of a system for simultaneously displaying video information and supplemental information on a screen, the illustrated example is only an example, and it should be understood that various alternatives and modifications can be devised by those skilled in the art without departing from the spirit and scope of the invention as defined by the appended claims.

What is claimed is:

1. A method for simultaneously displaying a video program and supplemental information, comprising:
converting a first video content to a format wherein the first video content is reduced in size and displayed on a first portion of a display; and
converting data associated with the supplemental information to a format wherein at least one of textual content and graphic content representing at least a portion of the supplemental information is displayed on a second portion of the display different from the first portion of the display at the same time as the first video content is displayed on the first portion of the display.

2 The method of claim 1, wherein the first video content is a television program which has been broadcasted and received by a television and the supplemental information is program information received by the television and relating to the television program.

3. The method of claim 2, wherein the program information includes channel and broadcast time information relating to the television program.

4. The method of claim 3, wherein the converting data step selectively converts specific portions of the supplemental information in response to signals output from a user input device.

5. The method of claim 4, wherein each of the specific portions of the supplemental information relates to a portion of a description of the television program.

6. The method of claim 1, wherein the supplemental information is program information relating to a plurality of video programs.

7. The method of claim 6, wherein the converting data step selectively converts specific portions of the supplemental information in response to signals output from a user input device, and wherein each of the specific portions of the supplemental information relates to program information corresponding to a respective one of the plurality of video programs.

8. The method of claim 7, wherein each of the plurality of programs is a broadcast television program which is either broadcast over a channel different from a channel on which the first video program is broadcast or is broadcast at a time different from a time when the first video program is broadcast.

9. The method of claim 1, wherein the supplemental information is message information intended to be conveyed to a user.

10. The method of claim 9, wherein the converting data step selectively converts specific portions of the supplemental information in response to signals output from a user input device, and wherein each of the specific portions of the supplemental information relates to corresponding portions of a message.

11. The method of claim 10, wherein the message information is advertising information.

12. The method of claim 1, wherein the first video content is represented by data retrieved on demand from a server via a connection to the server.

13. The method of claim 12, wherein the connection to the server is made via the internet.

14. The method of claim 13, wherein the connection uses TCP/IP protocol.

15. The method of claim 1, wherein the display is a television screen.

16. The method of claim 15, wherein the television screen is a high definition screen.

17. The method of claim 1, wherein the first portion of the display is a majority of the display.

18. The method of claim 1, wherein the first portion of the display is approximately 80% of the display.

19. A computer system adapted to simultaneously display a video program and supplemental information, comprising:
a processor; and
a memory including software instructions adapted to enable the computer system to perform the steps of:
converting a first video content to a format wherein the first video content is reduced in size and displayed on a first portion of a display; and
converting data associated with the supplemental information to a format wherein at least one of textual content and graphic content representing at least a portion of the supplemental information is displayed on a second portion of the display different from the first portion of the display at the same time as the video content is displayed on the first portion of the display.

20. The computer system as set forth in claim 19, wherein the first video content is a television program which has been broadcasted and received by a television and the supplemental information is program information relating to the television program.

21. The computer system as set forth in claim 20, wherein the program information includes channel and broadcast time information relating to the television program.

22. The computer system as set forth in claim 21, wherein the converting data step selectively converts specific portions of the supplemental information in response to a user input device.

23. The computer system as set forth in claim 22, wherein each of the specific portions of the supplemental information relates to a portion of a description of the television program.

24. The computer system as set forth in claim 19, wherein the supplemental information is program information relating to a plurality of video programs.

25. The computer system as set forth in claim 24, wherein the converting data step selectively converts specific portions of the supplemental information in response to a user input device, and wherein each of the specific portions of the supplemental information relates to program information corresponding to a respective one of the plurality of video programs.

26. The computer system as set forth in claim 25, wherein each of the plurality of programs is a broadcast television program which is either broadcast over a channel different from a channel on which the first video program is broadcast or is broadcast at a time different from a time when the first video program is broadcast.

27. The computer system as set forth in claim 19, wherein the supplemental information is message information intended to be conveyed to a user.

28. The computer system as set forth in claim 27, wherein the converting data step selectively converts specific portions of the supplemental information in response to a user input device, and wherein each of the specific portions of the supplemental information relates to corresponding portions of a message.

29. The computer system as set forth in claim 28, wherein the message information is advertising information.

30. The computer system as set forth in claim 19, wherein said processor and said memory are incorporated within a television receiver.

31. The computer system of claim 19, wherein the display is a television screen.

32. The computer system of claim 31, wherein the television screen is a high definition screen.

33. The computer system of claim 19, wherein the first video content is represented by data retrieved on demand from a server via a connection to the server.

34. The computer system of claim 33, wherein the connection to the server is made via the internet

35. The computer system of claim 34, wherein the connection uses TCP/IP protocol.

36. The computer system of claim 19, wherein the first portion of the display is a majority of the display.

37. The computer system of claim 19, wherein the first portion of the display is approximately 80% of the display.

38. An apparatus for simultaneously displaying a video program and supplemental information, comprising:
means for converting a first video content to a format wherein the first video content is reduced in size and displayed on a first portion of a display; and
means for converting data associated with the supplemental information to a format wherein at least one of textual content and graphic content representing at least a portion of the supplemental information is displayed on a second portion of the display different from the first portion of the display at the same time as the first video content is displayed on the first portion of the display.

39. The apparatus of claim 38, wherein the first video content is a television program which has been broadcasted and received by a television and the supplemental information is program information relating to the television program.

40. The apparatus of claim 39, wherein the program information includes channel and broadcast time information relating to the television program.

41. The apparatus of claim 40, wherein the means for converting data selectively converts specific portions of the supplemental information in response to a user input device.

42. The apparatus of claim 41, wherein each of the specific portions of the supplemental information relates to a portion of a description of the television program.

43. The apparatus of claim 42, wherein the supplemental information is program information relating to a plurality of video programs.

44. The apparatus of claim 43, wherein the means for converting data selectively converts specific portions of the supplemental information in response to a user input device, and wherein each of the specific portions of the supplemental information relates to program information corresponding to a respective one of the plurality of video programs.

45. The apparatus of claim 44, wherein the first video content is a first broadcast television program and each of the plurality of programs is a broadcast television program which is either broadcast over a channel different from a channel on which the first television program is broadcast or is broadcast at a time different from a time when the first television program is broadcast.

46. The apparatus of claim 38, wherein the supplemental information is message information intended to be conveyed to the viewer.

47. The apparatus of claim 46, wherein the means for converting data selectively converts specific portions of the supplemental information in response to a user input device, and wherein each of the specific portions of the supplemental information relates to corresponding portions of a message.

48. The apparatus of claim 47, wherein the message information is advertising information.

49. The apparatus of claim 38, wherein the display is a television screen.

50. The apparatus of claim 49, wherein the television screen is a high definition screen.

51. The apparatus of claim 38, wherein the first video content is represented by data retrieved on demand from a server via a connection to the server.

52. The apparatus of claim 51, wherein the connection to the server is made via the internet.

53. The apparatus of claim 52, wherein the connection uses TCP/IP protocol.

54. The apparatus of claim 38, wherein the first portion of the display is a majority of the display.

55. The apparatus of claim 38, wherein the first portion of the display is approximately 80% of the display.

56. A computer program product for enabling a computer to simultaneously display a video program and supplemental information comprising:
software instructions for enabling the computer to perform predetermined operations, and
a computer readable medium bearing the software instructions;
the predetermined operations including the steps of:
converting a first video content to a format wherein the first video content is reduced in size and displayed on a first portion of a display; and
converting data associated with the supplemental information to a format wherein at least one of textual content and graphic content representing at least a portion of the supplemental information is displayed on a second portion of the display different from the first portion of the display at the same time as the video content is displayed on the first portion of the display.

57. The computer program product as set forth in claim 56, wherein the first video content is a television program which has been broadcasted and received by a television and the supplemental information is program information relating to the television program.

58. The computer program product as set forth in claim 57, wherein the program information includes channel and broadcast time information relating to the television program.

59. The computer program product as set forth in claim 58, wherein the converting data step selectively converts specific portions of the supplemental information in response to a user input device.

60. The computer program product as set forth in claim 59, wherein each of the specific portions of the supplemental information relates to a portion of a description of the television program.

61. The computer program product as set forth in claim 56, wherein the supplemental information is program information relating to a plurality of video programs.

62. The computer program product as set forth in claim 61, wherein the converting data step selectively converts specific portions of the supplemental information in response to a user input device, and wherein each of the specific portions of the supplemental information relates to program information corresponding to a respective one of the plurality of video programs.

63. The computer program product as set forth in claim 62, wherein each of the plurality of programs is a broadcast television program which is either broadcast over a channel different from a channel on which the first video program is broadcast or is broadcast at a time different from a time when the first video program is broadcast.

64. The computer program product as set forth in claim 56, wherein the supplemental information is message information intended to be conveyed to a user.

65. The computer program product as set forth in claim 64, wherein the converting data step selectively converts specific portions of the supplemental information in response to a user input device, and wherein each of the specific portions of the supplemental information relates to corresponding portions of a message.

66. The computer program product of claim 65, wherein the message information is advertising information.

67. The computer program product of claim 56, wherein the display is a television screen.

68. The computer program product of claim 67, wherein the television screen is a high definition screen.

69. The computer program product of claim 56, wherein the first video content is represented by data retrieved on demand from a server via a connection to the server.

70. The computer program product of claim 69, wherein the connection to the server is made via the internet.

71. The computer program product of claim 70, wherein the connection uses TCP/IP protocol.

72. The computer program product of claim 56, wherein the first portion of the display is a majority of the display.

73. The computer program product of claim 56, wherein the first portion of the display is approximately 80% of the display.
